(19) United States
(12) Patent Application Publication
(10) Pub. No.: US 2026/0300733 A1
(43) Pub. Date: Oct. 1, 2026

(54) Compression Aware Training of a Neural Network Model

(71) Applicant: MediaTek Inc., Hsinchu City (TW)

(72) Inventors: Chun-Wei Yang, Hsinchu City (TW); Sheng-Je Hung, Hsinchu City (TW); Kai-Ling Huang, Hsinchu City (TW); Po-Yu Chen, Hsinchu City (TW)

(21) Appl. No.: 19/635,735

(22) Filed: Mar. 31, 2026

Related U.S. Application Data
(60) Provisional application No. 63/781,444, filed on Apr. 1, 2025.

(51) Int. Cl. G06N 3/082; G06N 3/084

(52) U.S. Cl. CPC G06N 3/082; G06N 3/084

(57) ABSTRACT

A neural network model is trained to be optimized for deployment on a target device. Executing a forward pass includes: performing a first optimization on a high-precision weight tensor to produce a weight tensor having a precision error; performing a second optimization on an activation output of an operation that operating on an input and the weight tensor having the precision error; calculating an accuracy loss between the activation output and a labeled output; and calculating a compression entropy caused by lossless compression to be performed by the target device on the weight tensor. Executing the backward pass includes updating the high-precision weight tensor using gradient descent based on a sum of the accuracy loss and the compression entropy. After iterations of the forward pass and the backward pass, an updated weight tensor is deployed on the target device for neural network inference.

### CROSS-REFERENCE TO RELATED APPLICATIONS

This application claims the benefit of U.S. Provisional Application No. 63/781,444 filed on Apr. 1, 2025, the entirety of which is incorporated by reference herein.

### TECHNICAL FIELD

Embodiments of the invention relate to training a neural network model optimized for deployment on a target device.

### BACKGROUND OF THE INVENTION

Various optimization techniques have been developed to reduce computational demands and memory footprint of neural networks. Such optimization techniques make it feasible to deploy a neural network on a memory-constrained platform, such as a mobile device. For example, quantization can be applied to neural network models to convert high-precision data formats (e.g., 32-bit or 16-bit floating point numbers) to lower-precision formats (e.g., 8-bit or 4-bit integers). However, quantization introduces accuracy loss. The impact to model accuracy can be significant when a model is quantized after training. Re-training a quantized model can be time-consuming and costly.

Therefore, there is a need for techniques that can optimize a neural network model for a memory-constrained platform while maintaining model performance.

### SUMMARY OF THE INVENTION

In one embodiment, a method is provided for training a neural network model optimized for deployment on a target device. The method comprises executing a forward pass on the neural network model. Executing the forward pass further includes: performing a first optimization on a high-precision weight tensor to produce a weight tensor having a precision error; performing a second optimization on an activation output of an operation (OP) of the neural network model, the OP operating on an input and the weight tensor having the precision error; calculating an accuracy loss between the activation output and a labeled output provided by a training database; and calculating a compression entropy caused by lossless compression to be performed by the target device on the weight tensor. The method further comprises executing a backward pass on the neural network model. Executing the backward pass includes updating the high-precision weight tensor using gradient descent based on a sum of the accuracy loss and the compression entropy. After iterations of the forward pass and the backward pass, an updated weight tensor is deployed on the target device for neural network inference.

In another embodiment, a method is provided for training a neural network model optimized for deployment on a target device. The method comprises executing a forward pass on the neural network model. Executing the forward pass includes: performing a first optimization on a high-precision weight tensor to produce a weight tensor having a precision error, the first optimization including cluster encoding an input tensor, which includes at least a subset of elements of the high-precision weight tensor, the cluster encoding further comprising: normalizing the input tensor to a predetermined range before calculating centroids of respective clusters, wherein the predetermined range is supported by hardware of the target device; and de-normalizing a cluster-encoded tensor. Executing the forward pass further includes: performing a second optimization on an activation output of an operation (OP) of the neural network model, the OP operating on an input and the weight tensor having the precision error; and calculating an accuracy loss between the activation output and a labeled output provided by a training database. The method further comprises executing a backward pass on the neural network model. Executing the backward pass includes updating the high-precision weight tensor using gradient descent based on a total loss including the accuracy loss. After iterations of the forward pass and the backward pass, an updated weight tensor is deployed on the target device for neural network inference.

In yet another embodiment, a system is provided for training a neural network model optimized for deployment on a target device. The system includes processors and a system memory coupled to the processors. The processors are operative to perform the aforementioned methods.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a flow diagram illustrating a model training process according to one embodiment.

FIG. 2A is a block diagram illustrating a pruning module according to one embodiment.

FIG. 2B is a block diagram illustrating an encoder according to one embodiment.

FIG. 2C is a block diagram illustrating a quantization-dequantization module according to one embodiment.

FIG. 3 is a flow diagram illustrates operations of an encoder according to one embodiment.

FIG. 4 is a diagram illustrating differentiable compression entropy calculations according to one embodiment.

FIG. 5 is a flow diagram illustrating a process for compression-aware training of a neural network model according to one embodiment.

FIG. 6 is a flow diagram illustrating a method performed by a computer system to train a neural network model that is optimized for deployment on a target device according to one embodiment.

FIG. 7 is a flow diagram illustrating a method performed by a computer system to train a neural network model that is optimized for deployment on a target device according to another embodiment.

FIG. 8 is a block diagram illustrating a computer system and a target device according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

This disclosure describes a method and system for optimizing a neural network model (also referred to as “model”) to run on an edge device with limited memory. In one embodiment, a model is compressed by one or more techniques in the training process to optimize its execution on a target device. Each iteration of the training process includes a forward pass, during which accuracy loss is accumulated, and a backward pass, during which model weights are updated based on a loss gradient. In one embodiment, a target-device-dependent compression loss is added to the accumulated accuracy loss in the forward pass to generate a total loss, and the total loss is used to calculate the loss gradient in the backward pass.

The disclosed method and system are applicable to a wide range of training processes and model types, including but not limited to: large vision models, large language models (LLMs), low-rank adaptation (LoRA) training, etc.

As used herein, the term “target device” refers to an edge device on which a neural network model that is trained according to the disclosed method is deployed. A target device is typically memory-constrained.

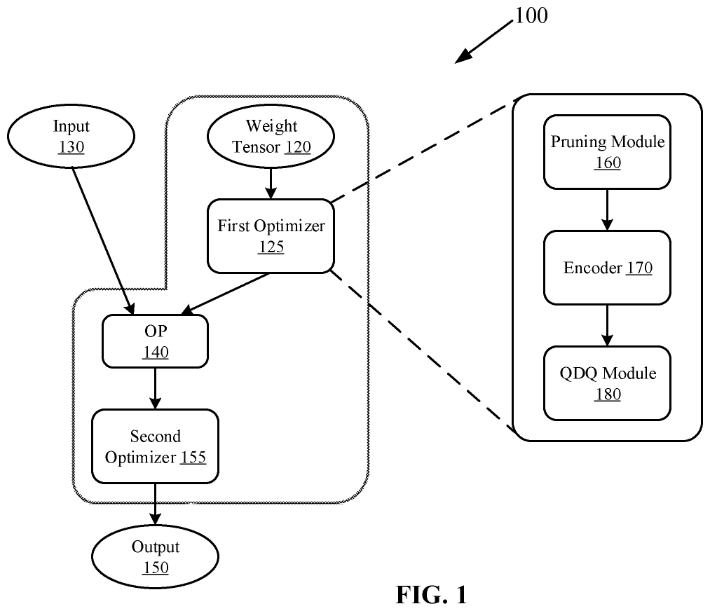

FIG. 1 is a flow diagram illustrating a model training process 100 according to one embodiment. To simplify the description, a model is shown to include a single layer of one operation as an example. It is understood that the disclosed training process can be applied to a neural network model that includes any number of layers and any number of operations.

In one embodiment, the process 100 begins with a first optimizer 125 operating on a weight tensor 120 of a neural network model. The weight tensor 120 is a tensor of two or more dimensions. The first optimizer 125 optimizes the weight tensor 120 for optimal deployment on a target device. A neural network operation (OP 140) operates on an input 130 and the output of the first optimizer 125, where the input 130 is also a tensor of two or more dimensions. One non-limiting example of the OP 140 is convolution. The OP 140 generates an activation output 150, which is fed into a second optimizer 155 to simulate low bit-width calculations supported by the hardware of a target device on which the neural network model is to be deployed. In an embodiment where a neural network model includes multiple layers of operations, the output of the second optimizer 155 becomes the input to a next layer. The process 100 repeats for each layer of the neural network model until all of the layers are processed. In one embodiment, the weight tensor 120 can be initialized using static optimization methods instead of starting training from scratch.

In one embodiment, the first optimizer 125 and the second optimizer 155 are configurable to include one or more optimizing modules, including but not limited to: a pruning module 160, an encoder 170, and a quantization-dequantization (QDQ) module 180. In one embodiment, the first optimizer 125 may include a different set of optimizing modules from the second optimizer 155. For example, the first optimizer 125 may include the encoder 170, the QDQ module 180, or a combination of both, and the second optimizer 155 includes at least the QDQ module 180. The operations of the first optimizer 125 and the second optimizer 155 optimize both the storage and the computational cost of a neural network model deployed on a resource-constrained target device. The first optimizer 125 and the second optimizer 155 are sometimes referred to as fake optimizers, as they do not exist in the inference phase of the neural network model. Rather, the first optimizer 125 and the second optimizer 155 are inserted into the forward pass in the training phase of the neural network model to incorporate awareness of the model's quality drop into a unified training flow, where the quality drop is caused by optimizations (e.g., pruning, cluster encoding, quantization, etc.) for target device deployment. The optimization sequence and techniques are not restricted to those mentioned herein.

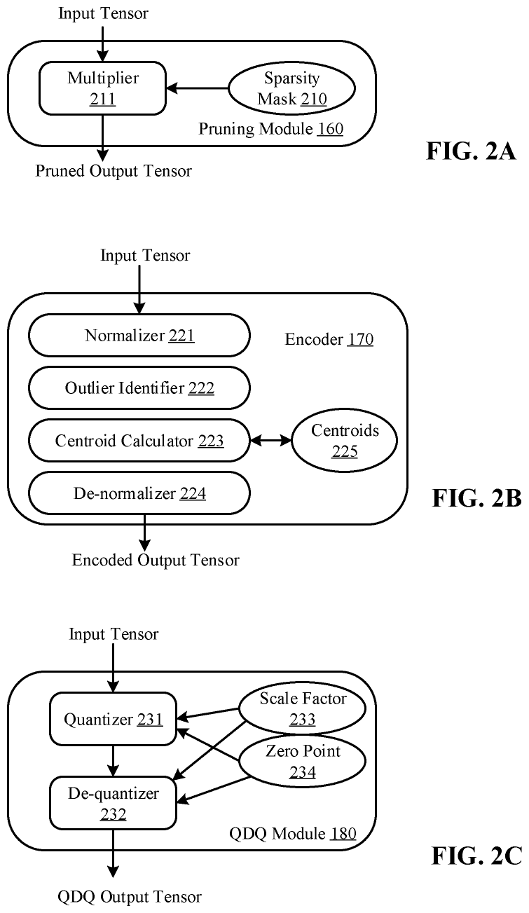

FIG. 2A is a block diagram illustrating the pruning module 160 according to one embodiment. In one embodiment, the pruning module 160 includes a multiplier 211 to multiply, element-wise, a sparsity mask 210 with the input tensor (e.g., the weight tensor 120). Pruning reduces the number of non-zero values in the input tensor. In one embodiment, the sparsity mask 210 is a tensor of the same dimensions as the input tensor, wherein each element of the mask corresponds to a respective value of the input tensor. The value of each mask element is either one or zero, and is applied to element-wise to the input tensor. A mask element of one indicates that the corresponding input tensor is retained, and a mask element of zero indicates that the corresponding input tensor is zeroed out. The sparsity mask 210 may be trainable or predetermined based on a predetermined pruning criterion (e.g., a magnitude threshold or the like) is applied to each weight to determine the value of its corresponding mask element.

FIG. 2B is a block diagram illustrating the encoder 170 according to one embodiment. In one embodiment, the encoder 170 encodes an input tensor using cluster encoding to reduce the number of distinct values to be stored. Cluster encoding groups tensor elements into clusters and uses the centroids of the respective clusters to represent the tensor elements. Compared to quantization, cluster encoding has a greater potential to more closely match the distribution of tensor elements. In an embodiment where the encoder 170 is preceded by the pruning module 160, the encoder's input tensor is the pruned output tensor. In an alternative embodiment, the encoder's input tensor is the weight tensor or the output activation tensor. In one embodiment, the encoder 170 includes a normalizer 221, which uses quantization parameters to normalize the input tensor of the encoder 170. The encoder 170 also includes an outlier identifier 222 to identify the outliers among the elements of the normalized tensor. The outliers do not contribute to centroid calculations. Outliers complicate the clustering process because they can distort cluster boundaries and make it harder to group similar data points accurately.

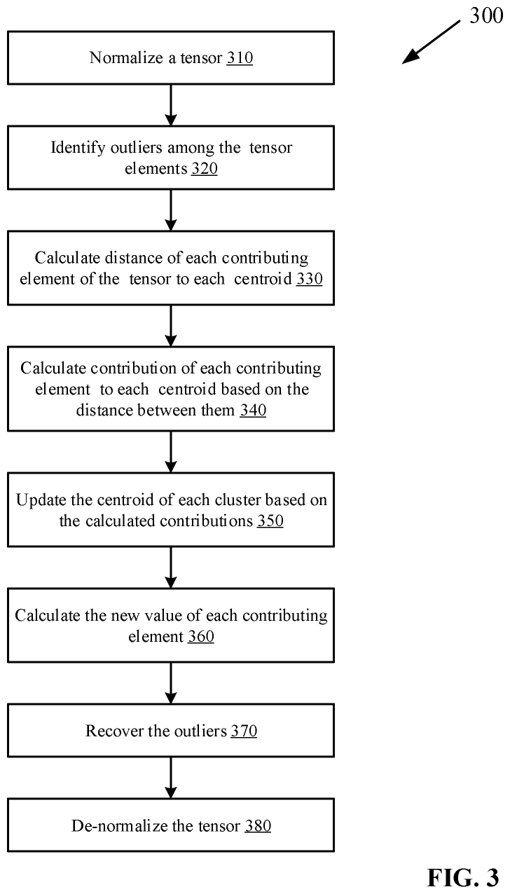

The encoder 170 also includes a centroid calculator 223, which iteratively calculates centroids 225 of respective clusters. The centroid calculations may be based on a K-means cluster algorithm, a variant of a K-means cluster algorithm, or any clustering algorithm. The encoder 170 also includes a de-normalizer 224 to de-normalize the cluster-encoded tensor. More details about the encoder 170 operation will be described with reference to FIG. 3.

FIG. 2C is a block diagram illustrating the QDQ module 180 according to one embodiment. The QDQ module 180 simulates the low-precision operations to be performed when the neural network model is executed on a target device. In one embodiment, the QDQ module 180 includes a quantizer 231 and a de-quantizer 232. The quantizer 231 quantizes an input tensor, which may be the encoded output tensor in an embodiment where the QDQ module 180 is preceded by the encoder 170. In alternative embodiments, the input tensor of the quantizer 231 may be the pruned output tensor, the weight tensor, the output activation tensor, or the output of another optimizing module. The quantizer 231 converts each element of the input tensor from a high-precision, high bit-width value (e.g., 32-bit or 16-bit floating-point value) to a lower-precision, lower bit-width value (e.g., 8-bit or 4-bit fixed-point or integer value). The lower bit-width value is the representation that is used by the target device to perform the neural network operation (e.g., OP 140). The quantizer 231 multiplies the input tensor by a scale factor 233 and adds a zero-point 234 to the scaled result. The scale factor 233 and the zero-point 234 are referred to as the quantization parameters, which are determined according to the bit-widths supported by the target device hardware. In one embodiment, a single scale factor and the corresponding zero point is used for the entire tensor. In another embodiment, each channel (e.g., row) of a tensor has its own scale factor and the corresponding zero point. In yet another embodiment, a fine-grained scale factor (and the corresponding zero point) may be applied to one or more tensor elements.

The de-quantizer 232 converts the output of the quantizer 181 back to the high bit-width representation using the same scale factor 233 and the zero-point 234 and generates a QDQ output tensor. The QDQ operations introduce a rounding error between the pre-quantized value and post-dequantized value, as the operations of mapping a high-precision value (e.g., 32-bit float-point) to a lower-precision value (e.g., 8-bit integer) and back involves rounding, which cannot be completely restored by the de-quantizer 232. The QDQ operations adds quantization effects into the forward pass, while maintaining high-precision computations for gradient updates in the backward pass.

In the examples of FIG. 2A, FIG. 2B, and FIG. 2C, parameters such as the sparsity mask 210, the scale factor 233, the zero point 234, and centroids 225 can be initialized using static optimization methods instead of starting training from scratch.

FIG. 3 is a flow diagram illustrates operations of the encoder 170 according to one embodiment. In one embodiment, the encoder 170 performs cluster encoding of a tensor, which includes a set of tensor elements and each tensor element is a scalar. The operations of the encoder 170 may also be referred to as compression, as the encoder's output size is less than the encoder's input size. Referring also to FIG. 2B, at step 310, the normalizer 221 of the encoder 170 normalizes the encoder's input tensor to a predetermined range. The predetermined range may be determined by the range of values supported by the target device hardware on which the neural network is to be deployed. Normalization improves compression quality by reducing the sensitivity of the compression to extreme values and preventing duplicate centroids after quantization. In one embodiment, the normalization is performed by dividing an input tensor by a scale factor and then adding a zero point to the division result. The scale factor and the zero point are the same quantization parameters (e.g., the scale factor 233 and the zero point 234) used by the DQD module 180 in FIG. 2C. Alternative normalization methods may also be used. At step 320, the outlier identifier 222 of the encoder 170 identifies outliers among the normalized tensor elements. Outliers are difficult to compress, so keeping these outliers un-clustered can improve trained model quality. In one embodiment, outliers may be identified by selecting the top m % of the largest absolute values of the tensor elements, where m is a predetermined number. Alternative methods for selecting the outliers may be used. The outlier values are stored for use at step 370. For ease of description, the normalized non-outlier tensor elements are called “contributing elements,” as they contribute to the centroid calculations. At step 330, the centroid calculator 223 of the encoder 170 calculates the discrepancy (e.g., distance) between each contributing element and each current centroid. Initially, each centroid may be initialized to a value using static optimization methods. At step 340, the centroid calculator 223 calculates the contribution of each contributing element to the current centroids. This contribution is based on the discrepancy; the closer a tensor element is to a centroid, the more it contributes to the new centroid of a cluster. Using a 2-D weight tensor as an example in the following steps,

$${contribution}_{ij - c} = \frac{{e}^{- dij - c}}{{\sum }_{i} {\sum }_{j} {e}^{- dij - c}} ,$$

which is the contribution of Wᵢⱼ to the c-th cluster. The contributions of the contributing elements form a near-binary distribution where a small number of elements have values close to one, and the rest are close to zero. The contribution of each outlier is set to zero to exclude its influence to the centroids update.

At step 350, the centroid calculator 223 calculates the new centroids. For example, new_centroid_{c}=(Σᵢ Σⱼ contribution_{ij-c}*Wᵢⱼ)/N, where N is the sum of contribution_{ij-c} for cluster c. The centroid values are iteratively updated until an ending criterion is met, e.g., when the centroid values converges or the number of iterations reaches a predetermined maximum value.

At step 360, the encoder 170 calculates the new value of each contributing element to be: new_centroid_{c}*contribution_{ij-c}. In one embodiment, the contributions are processed by a Gumbel-Softmax function, which transforms each contribution so that only a single element becomes one and all other elements become zero. In such an embodiment, the new value of each contributing element is set to be the new centroid of the cluster to which the contributing element belongs. At step 370, the values of the outliers collected at step 320 are recovered. The contributing elements with the new values and the outliers form a cluster-encoded tensor. At step 380, the de-normalizer 224 of the encoder 170 de-normalizes the cluster-encoded tensor to generate an encoded output tensor. In one embodiment, the de-normalization is performed by subtracting a zero point from the cluster-encoded tensor and then multiplying the subtraction result by a scale factor. The zero point and the scale factor are the same as those used by the normalizer 221 at step 310, and also the same as those used by the QDQ module 180 in FIG. 2C.

In one embodiment, after the target device receives the trained weights of a neural network model, the target device may compress the weights using a lossless compression scheme, such as Huffman encoding. Huffman encoding is a variable-length coding scheme that assigns shorter binary codewords to more frequently occurring values and longer codewords to less frequently occurring values to achieve reductions in storage size. For example, a variable-length code table can be constructed according to the frequency of each weight value. Because values that occur more frequently are encoded using fewer bits, Huffman encoding favors a compact distribution. In one embodiment, entropy is used as a metric for assessing the compactness of the distribution of weight values. Shannon entropy (hereinafter referred to as the “compression entropy”) provides a lower bound on the expected number of bits per value achievable by any lossless compression scheme, including Huffman encoding. The compression entropy H is defined as H=−Σ p(s) log₂ p(s), where the probability p(s) of value s is the ratio of the frequency of occurrence of value s in a tensor to the total number of elements in the tensor.

Higher compression entropy indicates a more uniform distribution, which means more bits needed to encode a tensor. On the other hand, lower compression entropy indicates a more concentrated distribution, which means fewer bits needed to encode tensors. In gradient descent training, reducing the compression entropy can result in a more concentrated distribution, allowing a tensor to be encoded with fewer bits by a target device.

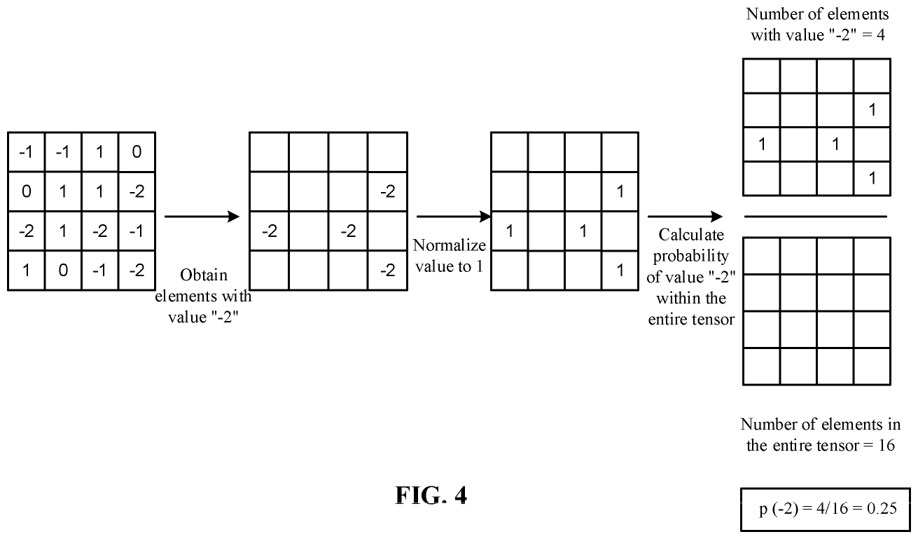

The compression entropy calculation steps include: (S1) calculate the probability (p) of each value to be encoded by the lossless compression, (S2) calculate p log₂(p) for each value, and (S3) sum the calculated p log₂(p) of each value and then multiply the sum by (−1) to obtain the compression entropy. Steps (S2) and (S3) are differentiable. Step (S1) can be made differentiable; an example of a differentiable step (S1) is illustrated in FIG. 4.

FIG. 4 is a diagram illustrating an example of differentiable compression entropy calculations according to one embodiment. In this example, the probability of value “−2”, denoted as p (−2), in a (4×4) tensor is calculated. The calculation can be performed in three steps. Firstly, tensor elements with value “−2” are identified. The rest of the elements can be masked, e.g., set to 0. Secondly, the values of the identified tensor elements are normalized to 1. Thirdly, p (−2) is calculated as (the number of the identified tensor elements) divided by (the number of elements in the entire tensor). The number of the identified tensor elements can be calculated by summing the values of all tensor elements (i.e., all tensor elements having the normalized value of 1). In this example, p (−2)=4/16=0.25. The entire calculation involves only multiplication, division, and addition, all of which are differentiable operations.

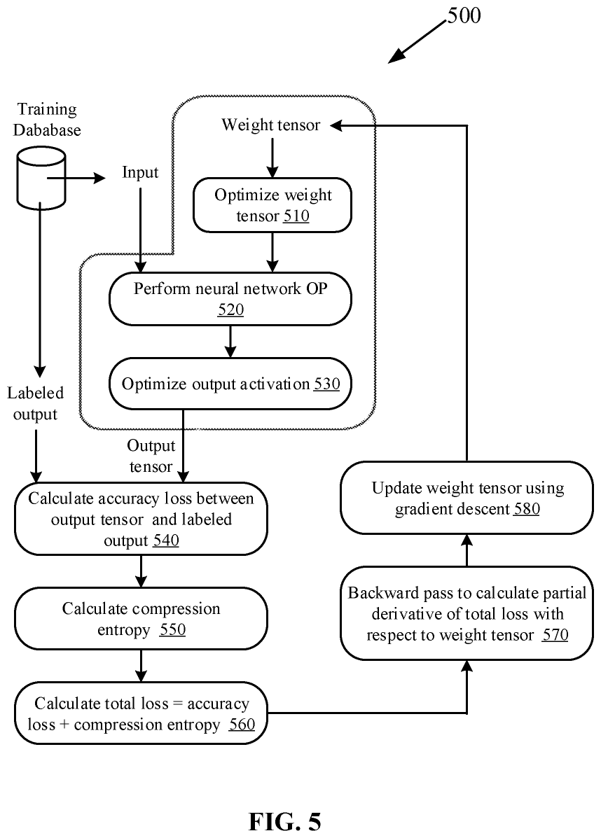

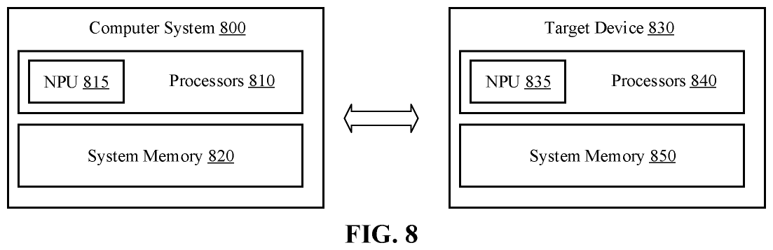

FIG. 5 is a flow diagram illustrating a training process 500 for compression-aware training of a neural network model according to one embodiment. In one embodiment, the training process 500 may be performed by a computer system, such as the computer system 800 in FIG. 8.

Referring also to FIG. 1, the computer system at step 510 uses the first optimizer 125 to optimize a high-precision weight tensor to a weight tensor having a precision error. The first optimizer 125 may include but are not limited to one or more of the pruning module 160, the encoder 170, and the QDQ module 180. The computer system at step 520 performs a neural network operation (OP) on an input from a training database and the weight tensor having the precision error to generate an output activation. At step 530, the computer system uses the second optimizer 155 to optimizes the output activation to an output tensor with an additional precision error. The second optimizer 155 includes the QDQ module 180 and may additionally include but are not limited to one or both of the pruning module 160 and the encoder 170. The computer system at step 540 calculates an accuracy loss between the output tensor and a labeled output (e.g., the ground truth) provided by the training database. The accuracy loss may be calculated by mean square error, cross-entropy, etc. At step 550, the computer system calculates a compression entropy of the weight tensor with the precision error generated at step 510. The compression entropy is from the lossless compression to be performed by the target device on which the neural network model is to be deployed. At step 560, the computer system adds the compression entropy to the accuracy loss to produce a total loss. Steps 510-560 form the forward pass of the training process 500. In an embodiment where the neural network model includes multiple layers, steps 510-560 are repeated for each layer and the total loss from each layer and its corresponding weight tensor is aggregated. At step 570, the computer system performs the backward pass in which the partial derivatives of the total loss with respect to the weight tensor are calculated. At step 580, the computer system updates the high-precision weight tensor (i.e., the weight tensor before optimized by the first optimizer 125 in the same iteration) using a gradient descent method. Steps 510-580 are repeated until an ending criterion is met, e.g., when the weight tensor value converges or when a maximum number of iterations is reached. When the process 500 terminates, the weight tensor is the trained weight tensor that can be deployed on a target device.

In one embodiment, the trained weight tensor can be provided to the target device in a codebook containing quantized values of cluster centroids and outliers. An index tensor of the same shape as the trained weight tensor is also provided to the target device. Each element of the index tensor is an index pointing to its corresponding centroid in the codebook. The cluster encoding scheme reduces the memory footprint of the weight tensor by representing the weight tensor with low bit-width centroids and integer indices.

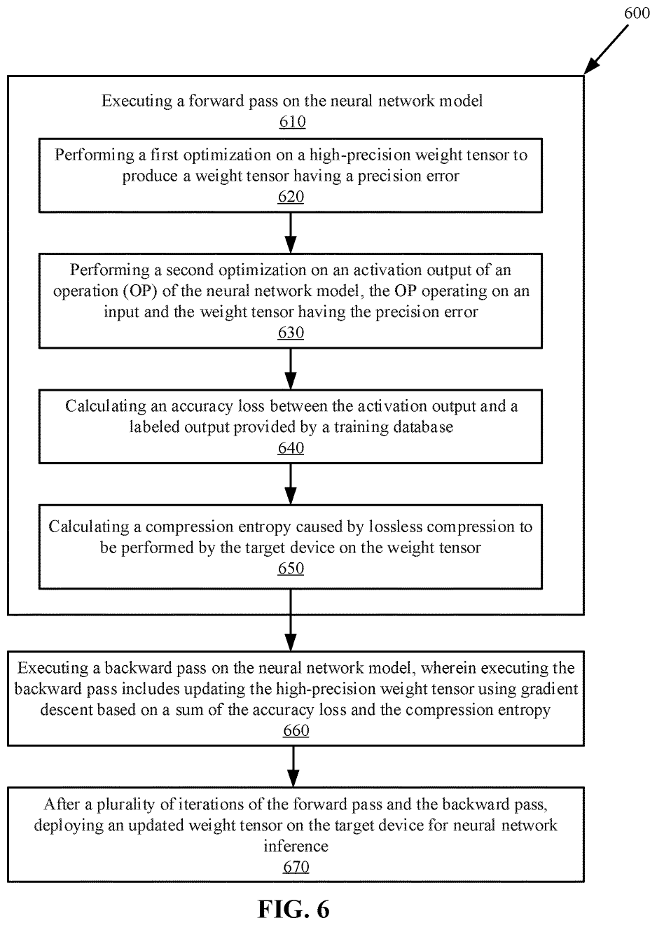

FIG. 6 is a flow diagram illustrating a method 600 performed by a computer system to train a neural network model that is optimized for deployment on a target device according to one embodiment. An example of the computer system and the target device is illustrated in FIG. 8.

In one embodiment, the method 600 begins at step 610 with a computer system executing a forward pass on a neural network model. When executing the forward pass, the computer system at step 620 performs a first optimization on a high-precision weight tensor to produce a weight tensor having a precision error. The computer system at step 630 performs a second optimization on an activation output of an operation (OP) of the neural network model. The OP operates on an input and the weight tensor having the precision error. The computer system at step 640 calculates an accuracy loss between the activation output and a labeled output provided by a training database. The computer system at step 650 calculates a compression entropy caused by lossless compression to be performed by the target device on the weight tensor.

Subsequent to the forward pass, the computer system at step 660 executes a backward pass on the neural network model. Executing the backward pass includes updating the high-precision weight tensor using gradient descent based on a sum of the accuracy loss and the compression entropy. After multiple iterations of the forward pass and the backward pass, the computer system at step 670 deploys an updated weight tensor on the target device for neural network inference.

In one embodiment, performing one of the first optimization and the second optimization further comprises performing one or more of pruning, clustering encoding, and QDQ on an input tensor.

In one embodiment, performing one of the first optimization and the second optimization further comprises performing cluster encoding on an input tensor. Performing the cluster encoding further comprises: normalizing the input tensor to a predetermined range before calculating centroids of respective clusters, and de-normalizing an output tensor of the cluster encoding. The predetermined range is supported by hardware of the target device. In one embodiment, performing the cluster encoding further comprises: identifying outliers in the normalized input tensor including a plurality of tensor elements, iteratively updating centroids of respective clusters of the tensor elements excluding the outliers, and de-normalizing the output tensor including updated centroids and the outliers.

In one embodiment, performing one of the first optimization and the second optimization further comprises performing cluster encoding followed by QDQ on an input tensor. The cluster encoding and the QDQ use same quantization parameters to perform normalization and quantization, respectively, on respective input tensors. The quantization parameters include one or more scale factors and one or more zero points.

In one embodiment, the lossless compression is Huffman encoding. In one embodiment, calculating the compression entropy further comprises performing differentiable calculations of a probability of each weight value in the trained weight tensor.

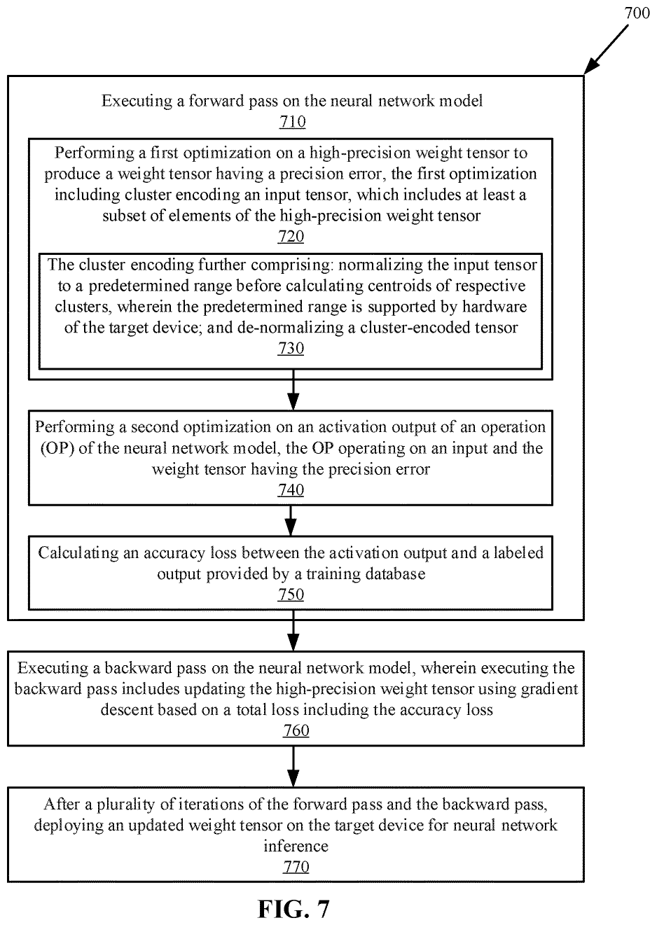

FIG. 7 is a flow diagram illustrating a method 700 performed by a computer system to train a neural network model that is optimized for deployment on a target device according to another embodiment. An example of the computer system and the target device is illustrated in FIG. 8.

In one embodiment, the method 700 begins at step 710 with a computer system executing a forward pass on a neural network model. When executing the forward pass, the computer system at step 720 performs a first optimization on a high-precision weight tensor to produce a weight tensor having a precision error. The first optimization includes cluster encoding an input tensor. The input tensor includes at least a subset of elements of the high-precision weight tensor. The computer system at step 730 performs the cluster encoding, which further includes: normalizing the input tensor to a predetermined range before calculating centroids of respective clusters, and de-normalizing a cluster-encoded tensor. The predetermined range is supported by hardware of the target device. The computer system at step 740 performs a second optimization on an activation output of an operation (OP) of the neural network model. The OP operates on an input and the weight tensor having the precision error. The computer system at step 750 calculates an accuracy loss between the activation output and a labeled output provided by a training database.

Subsequent to the forward pass, the computer system at step 760 executes a backward pass on the neural network model. Executing the backward pass includes updating the high-precision weight tensor using gradient descent based on a total loss including the accuracy loss. After multiple iterations of the forward pass and the backward pass, the computer system at step 770 deploys an updated weight tensor on the target device for neural network inference.

In one embodiment, executing the forward pass further comprises: calculating a compression entropy caused by lossless compression to be performed by the target device on the weight tensor, and adding the compression entropy to the accuracy loss to obtain the total loss for the gradient descent. In one embodiment, the lossless compression is Huffman encoding.

In one embodiment, the cluster encoding further comprises: identifying outliers in the normalized input tensor including a plurality of tensor elements, iteratively updating the centroids of the respective clusters of the tensor elements excluding the outliers, and generating the cluster-encoded tensor for the de-normalization, the cluster-encoded tensor including updated centroids and the outliers.

In one embodiment, the first optimization includes the cluster encoding followed by quantization-dequantization (QDQ), wherein the cluster encoding and the QDQ use same quantization parameters to perform normalization and quantization, respectively, on respective input tensors, wherein the quantization parameters include one or more scale factors and one or more zero points.

In one embodiment, performing the second optimization further comprises: performing one or both of pruning and the clustering encoding on the output activation in addition to quantization-dequantization (QDQ).

FIG. 8 is a block diagram illustrating a computer system 800 and a target device 830 according to one embodiment. The computer system 800 may be a computer, a server, a laptop, or any computing device. The computer system 800 includes processors 810 coupled to a system memory 820. The processors 810 include general-purpose processors and special-purpose processing circuits. The processors 810 includes a neural processing unit (NPU) 815. The NPU 815 is also known as an AI accelerator in some system. The processors 810 may also include a central processing unit (CPU), a digital signal processor (DSP), a graphics processing unit (GPU), etc. In one embodiment, the processors 810 are operative to perform the encoder operations of FIG. 3, the training process 500 of FIG. 5, the method 600 of FIG. 6, and/or the method 800 of FIG. 8.

The system memory 820 may include memory devices such as dynamic random-access memory (DRAM) modules, static RAM (SRAM) modules, flash memory devices, and/or other volatile or non-volatile memory devices. Although the system memory 820 is represented by one block in FIG. 8, it is understood that the system memory 820 may include multiple memory devices across multiple levels of memory hierarchy. It is understood that the target device 800 is simplified for illustration; additional hardware and software components (e.g., network interface, display, user interface, etc.) are not shown.

In one embodiment, the target device 830 includes processors 840 coupled to a system memory 850. The processors 840 includes general-purpose processors and special-purpose processing circuits. The processors 840 includes an NPU 835, and may also include a CPU, a DSP, a GPU, etc. In one embodiment, the processors 840 are operative to perform lossless compression on a weight tensor received from the computer system 800 to reduce storage space. The weight tensor has been optimized for the target device 830 by the computer system 800 for performing neural network inference. The processors 840 are further operative to perform the neural network inference using the optimized weight tensor.

The system memory 850 may include memory devices such as DRAM modules, SRAM modules, flash memory devices, and/or other volatile or non-volatile memory devices. It is understood that the system memory 850 may include multiple memory devices across multiple levels of memory hierarchy. It is understood that the target device 850 is simplified for illustration; additional hardware and software components (e.g., network interface, display, user interface, etc.) are not shown.

The target device 830 can have any form factor. Non-limiting examples of the target device 830 include a smartphone, smart appliance, a desktop computer, a laptop, an Internet-of-Things (IoT) device, an autonomous vehicle, a wearable device, etc.

The operations of the flow diagrams of FIG. 3, FIG. 5, FIG. 6, and FIG. 7 have been described with reference to the exemplary embodiment of FIG. 8. However, it should be understood that the operations of the flow diagrams of FIG. 3, FIG. 5, FIG. 6, and FIG. 7 can be performed by embodiments of the invention other than the embodiment of FIG. 8, and the embodiment of FIG. 8 can perform operations different than those discussed with reference to the flow diagrams. It is understood that the order of operations shown in the flow diagrams of FIG. 3, FIG. 5, FIG. 6, and FIG. 7 is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method of training a neural network model optimized for deployment on a target device, comprising:
executing a forward pass on the neural network model, wherein executing the forward pass includes:
performing a first optimization on a high-precision weight tensor to produce a weight tensor having a precision error;
performing a second optimization on an activation output of an operation (OP) of the neural network model, the OP operating on an input and the weight tensor having the precision error;
calculating an accuracy loss between the activation output and a labeled output provided by a training database; and
calculating a compression entropy caused by lossless compression to be performed by the target device on the weight tensor;
executing a backward pass on the neural network model, wherein executing the backward pass includes updating the high-precision weight tensor using gradient descent based on a sum of the accuracy loss and the compression entropy; and
after a plurality of iterations of the forward pass and the backward pass, deploying an updated weight tensor on the target device for neural network inference.

2. The method of claim 1, wherein performing one of the first optimization and the second optimization further comprises:
performing one or more of pruning, clustering encoding, and quantization-dequantization (QDQ) on an input tensor.

3. The method of claim 1, wherein performing one of the first optimization and the second optimization further comprises performing cluster encoding on an input tensor, and performing the cluster encoding further comprises:
normalizing the input tensor to a predetermined range before calculating centroids of respective clusters, wherein the predetermined range is supported by hardware of the target device; and
de-normalizing an output tensor of the cluster encoding.

4. The method of claim 3, wherein performing the cluster encoding further comprises:
identifying outliers in the normalized input tensor including a plurality of tensor elements;
iteratively updating centroids of respective clusters of the tensor elements excluding the outliers; and
de-normalizing the output tensor including updated centroids and the outliers.

5. The method of claim 1, wherein performing one of the first optimization and the second optimization further comprises performing cluster encoding followed by quantization-dequantization (QDQ) on an input tensor, and the cluster encoding and the QDQ use same quantization parameters to perform normalization and quantization, respectively, on respective input tensors, wherein the quantization parameters include one or more scale factors and one or more zero points.

6. The method of claim 1, wherein the lossless compression is Huffman encoding.

7. The method of claim 1, wherein calculating the compression entropy further comprises performing differentiable calculations of a probability of each weight value in the trained weight tensor.

8. A method of training a neural network model optimized for deployment on a target device, comprising:
executing a forward pass on the neural network model, wherein executing the forward pass includes:
performing a first optimization on a high-precision weight tensor to produce a weight tensor having a precision error, the first optimization including cluster encoding an input tensor, which includes at least a subset of elements of the high-precision weight tensor, the cluster encoding further comprising: normalizing the input tensor to a predetermined range before calculating centroids of respective clusters, wherein the predetermined range is supported by hardware of the target device; and de-normalizing a cluster-encoded tensor;
performing a second optimization on an activation output of an operation (OP) of the neural network model, the OP operating on an input and the weight tensor having the precision error; and
calculating an accuracy loss between the activation output and a labeled output provided by a training database;
executing a backward pass on the neural network model, wherein executing the backward pass includes updating the high-precision weight tensor using gradient descent based on a total loss including the accuracy loss; and
after a plurality of iterations of the forward pass and the backward pass, deploying an updated weight tensor on the target device for neural network inference.

9. The method of claim 8, wherein executing the forward pass further comprises:
calculating a compression entropy caused by lossless compression to be performed by the target device on the weight tensor; and
adding the compression entropy to the accuracy loss to obtain the total loss for the gradient descent.

10. The method of claim 9, wherein the lossless compression is Huffman encoding.

11. The method of claim 8, wherein the cluster encoding further comprises:
identifying outliers in the normalized input tensor including a plurality of tensor elements;
iteratively updating the centroids of the respective clusters of the tensor elements excluding the outliers; and
generating the cluster-encoded tensor for the de-normalization, the cluster-encoded tensor including updated centroids and the outliers.

12. The method of claim 1, wherein the first optimization includes the cluster encoding followed by quantization-dequantization (QDQ), wherein the cluster encoding and the QDQ use same quantization parameters to perform normalization and quantization, respectively, on respective input tensors, wherein the quantization parameters include one or more scale factors and one or more zero points.

13. The method of claim 8, wherein performing the second optimization further comprises:
performing one or both of pruning and the clustering encoding on the output activation in addition to quantization-dequantization (QDQ).

14. A system operative to train a neural network model optimized for deployment on a target device, comprising:
a plurality of processors; and
a system memory coupled to the processors, wherein the processors are operative to:
execute a forward pass on the neural network model, wherein the processors when executing the forward pass are further operative to:
perform a first optimization on a high-precision weight tensor to produce a weight tensor having a precision error;
perform a second optimization on an activation output of an operation (OP) of the neural network model, the OP operating on an input and the weight tensor having the precision error;
calculate an accuracy loss between the activation output and a labeled output provided by a training database; and
calculate a compression entropy caused by lossless compression to be performed by the target device on the weight tensor;
execute a backward pass on the neural network model, wherein executing the backward pass includes updating the high-precision weight tensor using gradient descent based on a sum of the accuracy loss and the compression entropy; and
after a plurality of iterations of the forward pass and the backward pass, deploy an updated weight tensor on the target device for neural network inference.

15. The system of claim 14, wherein the processors when performing one of the first optimization and the second optimization are further operative to:
perform one or more of pruning, clustering encoding, and quantization-dequantization (QDQ) on an input tensor.

16. The system of claim 14, wherein the processors when performing one of the first optimization and the second optimization are operative to perform cluster encoding on an input tensor, and when performing the cluster encoding the processors are further operative to:
normalize the input tensor to a predetermined range before calculating centroids of respective clusters, wherein the predetermined range is supported by hardware of the target device; and
de-normalize an output tensor of the cluster encoding.

17. The system of claim 16, when performing the cluster encoding the processors are further operative to:
identify outliers in the normalized input tensor including a plurality of tensor elements;
iteratively update centroids of respective clusters of the tensor elements excluding the outliers; and
de-normalize the output tensor including updated centroids and the outliers.

18. The system of claim 14, wherein when performing one of the first optimization and the second optimization the processors are further operative to:
perform cluster encoding followed by quantization-dequantization (QDQ) on an input tensor, and the cluster encoding and the QDQ use same quantization parameters to perform normalization and quantization, respectively, on respective input tensors, wherein the quantization parameters include one or more scale factors and one or more zero points.

19. The system of claim 14, wherein the lossless compression is Huffman encoding.

20. The system of claim 14, wherein the processors when calculating the compression entropy are further operative to:
perform differentiable calculations of a probability of each weight value in the trained weight tensor.
